(19) United States
(12) Patent Application Publication
(10) Pub. No.: US 2026/0317919 A1
(43) Pub. Date: Oct. 15, 2026

(54) An Electrolyser Cell Frame Assembly And An Electrolyser

(71) Applicant: OÜ Stargate Hydrogen Solutions, Tallinn (EE)

(72) Inventors: Jan Gustav Grolig, Tallinn (EE); Stina Rahnel, Tallinn (EE); Ardan Apaydin, Tallinn (EE); Arko Akenpärg, Tallinn (EE)

(73) Assignee: OÜ Stargate Hydrogen Solutions, Tallinn (EE)

(21) Appl. No.: 19/483,604

(22) PCT Filed: Dec. 5, 2024
(86) PCT No.: PCT/EP2024/063012

§ 371 Date: Nov. 11, 2025

(30) Foreign Application Priority Data
Nov. 5, 2023 (EP) 23020219.4

(51) Int. Cl. C25B 9/77; C25B 1/04; C25B 9/19; C25B 9/60; C25B 9/75

(52) U.S. Cl. CPC C25B 9/77; C25B 1/04; C25B 9/19; C25B 9/60; C25B 9/75

(57) ABSTRACT

The present invention discloses an electrolyser cell frame assembly comprising a cell frame with an inner peripheral edge and an outer peripheral edge; a gasket with an inner peripheral edge and an outer peripheral edge; and a cell element with a peripheral edge compressed between the gasket and the cell frame. The gasket exhibits compressible characteristics whereas the cell frame exhibits rigid characteristics. The outer peripheral edge of the gasket extends outwards over the peripheral edge of the cell element in the direction of the outer peripheral edge of the cell frame such that the gasket overlaps a predefined part of the cell frame.

### TECHNICAL FIELD

The present invention relates generally to an electrolyser, preferably an alkaline water electrolyser, and more specifically relates to a cell frame assembly of the alkaline water electrolyser.

### BACKGROUND

In alkaline water electrolysis, water is electrochemically converted into hydrogen and oxygen in alkaline conditions: H₂O═H₂+0.5O₂. An electrolysis cell comprises two electrodes: An anode and a cathode in an electrolyte. The electrolyte comprises a liquid alkaline medium such as an aqueous solution of hydroxides and/or carbonates. The alkaline electrolyte flows through the cells, which are connected fluidically in parallel, thereby immersing the electrodes in the electrolyte. During operation, an electric potential is applied between the two electrodes, resulting in the flow of electrolysis current through the electrolysis cell. During operation, hydrogen is generated on the cathode according to the hydrogen evolution reaction (HER): 2H₂O+2e⁻═H₂+2OH⁻, while oxygen is generated on the anode according to the oxygen evolution reaction (OER): 2OH⁻=0.5O₂+H₂O+2e⁻. The electrolysis cell further comprises a porous separator (diaphragm) and/or an ion exchange membrane capable of conducting hydroxide ions and separating both half-cells to prevent mixing of the product gases. The electrodes are placed on either side of the membrane in a sandwich-like manner.

It is advantageous to place the electrodes as close as possible to the membrane from both sides in a sandwich-like manner, which on one hand minimizes the distance between the electrodes and thus decreases the ionic resistance, and on other hand ensures that the hydrogen gas bubbles evolve mostly at the back side of the electrodes, which leads to reduced overpotentials. This arrangement, often referred to as “zero-gap configuration”, thus results in improved cell efficiency. The positioning of the electrodes for this configuration is achieved by pressing the electrodes and the cell membrane together and adjusting the contact pressure via elastic or rigid spacers placed next to the electrodes on the sides opposite to the side facing the cell membrane. Furthermore, electrical contact to the electrodes is established via the bipolar plates, which are in contact with the spacers.

The cells are typically assembled in series in a “cell stack”. The higher the number of cells in the stack, the more hydrogen and oxygen can be produced in unit time. Similarly, the larger the surface area (footprint) of each cell in the stack, the more hydrogen and oxygen can be produced per cell. The electrolyser stack consists of anode and cathode end plates and the cells are serially stacked between the end plates. In addition to providing electrical contact from cell to cell, bipolar plates also physically separate the anode side of one cell from the cathode side of an adjacent cell.

Each cell typically has a pair of cell frames that are essential for forming reaction chambers in the stack. The cell frames furthermore provide mechanical support to the cell components and in combination with gaskets prevent leakage of the alkaline electrolyte to the environment. However, most commonly the cell frames used on anode side are structurally different from the cell frames at cathode side, which is not a cost-efficient for manufacturing the cell frames.

A pressure electrolyser described in U.S. Pat. No. 7,591,932B2 comprises a cell frame made of two materials: an elastic material in longitudinal direction and the transverse direction of the electrolytic cell block. Secondly, the cell frame comprises a rigid material which runs in the circumferential direction, providing mechanical stability to the cell frame. The rigid material is connected to the elastic material, forming a shell-like frame structure or a frame-like insert. The elastic material of the cell frame is made of elastomer, or a soft elastic thermoplastic and the rigid material is made of metal or plastic. The drawback of this arrangement is that the electrolyte flowing through the alkaline electrolyser can affect the material of the elastic element over time, thus making it rigid, and by leaching out undesirable species from the elastic element. Furthermore, the system needs an additional pressure tank to enclose the electrolytic cell block to provide additional compression and insulation. The manufacturing process of the cell frame is also complicated due to the structure of the elastic material and the rigid material.

EP3696298A1 discloses a cell frame for an electrolysis or fuel cell block, with a receiving opening to receive a cell membrane and a plurality of collecting duct openings designed for electrolyte media discharge through the cell frame and a sealing structure which is used to seal the cell frame to the outside and/or the receiving opening and/or the duct openings is set up. The sealing structure is made up of a groove in the cell and a sealing element which is inserted in the groove. The sealing element is a cord seal or O-sealing ring. This setup requires multiple sealing elements to seal the cell, which increases design complexity of the cell frame and is not a cost-efficient option.

U.S. Pat. No. 8,349,151B2 describes a universal cell frame for Polymer Electrode Membrane (PEM) electrolyser. The cell frame has a central opening and four sets of transverse openings that are spaced 90 degrees apart. Two sets of openings being spaced apart at 180 degrees have internal pathways interconnected with central opening. The cell frame is configured to be used as anode frame as well as cathode frame by rotating the cell frame by 90 degrees. However, the presence of additional openings (essentially a “cross-flow” configuration) is not suitable for use in alkaline electrolyser, as product gases would become entrapped inside the cell frame with horizontal pathways. Furthermore, the surface area of the bipolar plate accommodates the inlet and outlet channels, hence the bipolar plates are in contact with the electrolyte passing through the channels. This arrangement increases the parasitic shunt currents flowing through the stack and results in reduced energy efficiency of the stack during operation.

EP3608445A1 (filed by THYSSENKRUPP on 2020 Feb. 12) disclose D1 discloses a cell assembly comprising a cathode gasket and an anode gasket wherein a porous diaphragm is held between the gaskets and the said gaskets are arranged between a cathode cell frame and an anode frame. However, the prior art it neglects to detail a mechanism for securing a bipolar plate within the cell assembly.

EP2993254 A1 and EP4151775A1 by ASAHI CHEMICAL filed on 2016 Mar. 9 and 2023 Mar. 22 respectively disclose a gasket designed to hold the cell element, with the gasket positioned between cell frames. The said gasket includes a slit for inserting the cell element, thereby securing it in place. However, it is crucial to note that the manufacturing complexity associated with such a design poses a significant disadvantage. The slit in the gasket is tailored to accommodate a specific cell element thickness, leading to manufacturing complexities when dealing with cell elements of varying thicknesses. This limitation is a fundamental drawback as it restricts the universal applicability of a single gasket configuration across cell elements of different thicknesses.

In the view of foregoing, there is a need for improved cell frame design that reduces complexity and cost of the cell frame fabrication and eases electrolyser assembly.

### DISCLOSURE OF INVENTION

The object underlying the present invention is to create a simplified alkaline electrolyser with an improved cell frame assembly in order to reduce internal leakage between the cells and provide a better sealing technique.

Another object of the present invention is to use a single gasket with a cell frame to provide sealing between adjacent cells as well as ensure that no leakage occurs from the cells to the outer environment.

Furthermore, the object of the invention is to design a cell frame assembly that provides mechanical support to the cell components of the stack using a single sealing component.

The above object of the present invention can be achieved by the following technical solutions:

The various embodiments of the present invention disclose an electrolyser cell frame assembly comprising a cell frame with an inner peripheral edge and an outer peripheral edge; a gasket with an inner peripheral edge and an outer peripheral edge; and a cell element with a peripheral edge compressed between the gasket and the cell frame. The gasket exhibits compressible characteristics whereas the cell frame exhibits rigid characteristics. The outer peripheral edge of the gasket extends outwards over the peripheral edge of the cell element in the direction of the outer peripheral edge of the cell frame such that the gasket overlaps a predefined part of the cell frame.

The inner peripheral edge of the gasket extends inwards over the peripheral edge of the cell element in the direction of the inner peripheral edge of the cell frame such that the gasket overlaps a predefined part of the cell element. The gasket is positioned to overlap the part of the cell frame and the part of the cell element along the entire peripheral edge of the cell element.

According to one embodiment herein, the cell frame comprises a central opening; a groove for accommodating the cell element; a plurality of transverse channels and at least two pathways, wherein each pathway interconnects at least one channel to the central opening.

According to one embodiment herein, the two pathways are spaced apart by about 180 degrees.

According to one embodiment herein, a bridge is positioned at junction of the pathway and the central opening.

According to one embodiment herein, the cell frame comprises a first surface and a second surface, wherein the groove is present on the first surface of the cell frame, wherein the pathways and the bridge are located on the second surface of the cell frame.

According to one embodiment herein, the gasket has at least two extended portions overlapping a predefined part of the cell frame around the channels and the pathways. The extended portion of the gasket comprises a plurality of apertures to accommodate the plurality of channels and the pathways.

According to one embodiment herein, the cell element is either a cell membrane or a bipolar plate.

According to one embodiment herein, the cell frame comprises a plurality of protruding parts and recesses that fit into each other to align the cell frame and the gasket in the cell frame assembly.

According to one embodiment herein, the groove comprises a spacing between a peripheral edge of the groove and the perimeter of the cell element to compensate thermal expansion or contraction of the cell element.

The present invention furthermore discloses an electrolyser, preferably alkaline water electrolyser. The electrolyser comprises a first end plate, a second end plate, and a plurality of cells serially stacked in-between the first end plate and the second end plate. Each cell comprises a bipolar-plate assembly, a cell-membrane assembly and a plurality of electrodes, and a plurality of spacers. The bipolar-plate assembly comprises a bipolar plate placed between a first cell frame and a first gasket. The first gasket is assembled to overlap a predefined part of the first cell frame and a predefined part of the bipolar plate. The cell-membrane assembly comprises a cell membrane between a second cell frame and a second gasket. The second gasket is assembled to overlap a predefined part of the second cell frame and a predefined part of the cell membrane placed in the groove. A first electrode and a first spacer are placed in-between the bipolar-plate assembly and the cell membrane assembly while a second electrode and a second spacer are placed in-between the cell-membrane assembly and the bipolar-plate assembly of an adjacent cell.

According to an embodiment herein, the first cell frame is structurally identical to the second cell frame. The bipolar-plate assembly and the cell-membrane assembly are arranged in an alternating pattern, wherein the first cell frame and the second cell frame are arranged by alternately rotating the cell frames by 180 degrees.

According to an embodiment herein, the first gasket of the bipolar-plate assembly is compressed between a cell frame of an adjacent cell-membrane assembly and the first cell frame and the bipolar plate of the bipolar-plate assembly, and wherein the second gasket of the cell-membrane assembly is compressed between the first cell frame of the bipolar-plate assembly and the second cell frame of the cell-membrane assembly.

According to an embodiment herein, the peripheral edge of the first electrode and the second electrode is either smaller than or equal to the inner peripheral edge of the cell frame. The peripheral edge of the first spacer and the second spacer is either smaller than or equal to the inner peripheral edge of the cell frame.

According to an embodiment herein, the total number of gaskets in the stack is one more than the number of cell frames, wherein an additional gasket is placed either after the first end plate or before the second end plate.

These and other objects and advantages of the present invention will become readily apparent from the following detailed description taken in conjunction with the accompanying drawings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The summary above, as well as the following detailed description of illustrative embodiments, is better understood when read in conjunction with the appended drawings. For the purpose of illustrating the present invention, exemplary constructions of the embodiments of the invention are shown in the drawings, with references to the following diagrams wherein:

FIG. 1 is an explanatory view of a cell frame assembly, according to a preferred embodiment of the present invention. FIG. 1A is a cross section view of the cell frame assembly, FIG. 1B is front view of the cell frame assembly.

FIG. 2 is a first surface and second surface of a cell frame, according to a preferred embodiment of the present invention.

FIG. 3 is a front view of a gasket with extended portions, according to a preferred embodiment of the present invention.

FIG. 4 is a cross sectional view of a cell arrangement comprising two cell frame assemblies, according to a preferred embodiment of the present invention.

FIG. 5 is a cross section views of the cell assembly to illustrate compression of gasket according to three different embodiments of the present invention. FIG. 5A is a cross section view of the cell assembly wherein the thickness of the cell element is same as the depth of the groove of the cell frame. FIG. 5B is a cross section view of the cell assembly wherein the thickness of the cell element is lesser than the depth of the groove of the cell frame. FIG. 5C is a cross section view of the cell assembly wherein the thickness of the cell element is greater than the depth of the groove of the cell frame.

It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein describe an electrolyser stack comprising a plurality of cells stacked between a first end plate and a second end plate. The end plates serve as positive and negative terminals, respectively, to which DC power is supplied. The plurality of cells stacked together in a particular order between the end plates. Each cell in the stack comprises of a plurality of cell components, including but not limited to at least two electrodes (one acting as an anode and other as cathode) placed on either side of a cell membrane, a bipolar plate placed between the cells, and a plurality of spacers placed next to the electrodes on either side of electrode-cell membrane-electrode assembly. The positioning of the electrodes close to the cell membrane is achieved by applying compression via the spacers. A plurality of channels extends from the first end plate through the stack, the channels branching into the respective cells through a plurality of pathways. An electrolyte solution enters the stack through the inlet channels and each individual cell is fed with the electrolyte solution via the pathways emanating from the channels. During electrolysis process, the humidified gases produced exit from the cells through the pathways and leave the stack through outlet channels along with the electrolyte solution. A plurality of cell frame assemblies ensures the sealing of cell components. Furthermore, the cell components are supported by the plurality of cell frame assemblies. Each cell comprises at least two cell frame assemblies wherein each cell assembly comprises a cell frame and a gasket. The end plates and the cells are compressed and clamped together using tie rods and bolts. The clamping provides sealing pressure and a proper pressure distribution between different cell components. The clamping also ensures electrical connection between the bipolar plates.

According to an embodiment of the present invention, the electrode can be shaped as perforated metal sheets with a porous surface, woven metal meshes or expanded metal sheets. The electrodes need to be long-term resistant against corrosion in alkaline environment as well as have good electrical conductivity and high electrochemical activity. The base material used in electrodes includes, but is not limited to, nickel containing material or steel substrate, where the steel substrate electrode needs to be coated with thin layer of nickel to avoid corrosion and facilitate catalytic activity. Furthermore, the electrode is preferably coated by an electrocatalyst to enable electrochemically activated surface, which improves the respective half-cell reaction. The electrocatalyst materials are preferably tailored to the half-cell reaction, thus the catalysts coating for cathode and anode differs. Preferably the cathode is often coated with a layer of Raney-nickel, Ruthenium dioxide (RuO₂), or other Mixed Metal Oxides (MMO's) and Molybdenum (Mo). Furthermore, nickel oxides and nickel and cobalt-based mixed oxides can also be used to further improve the electrochemical activity of the anode.

In the context of the present invention, the term “membrane” is used interchangeably with the terms “separator” and “diaphragm”, and refers to the stack component comprising a polymer, porous or non-porous, that is used to separate the anode from the cathode and through which hydroxide ions are transported. The membrane needs to have a high thermal, chemical, and electrochemical resistance. Zirconium oxide-polysulfonic acid membranes are the preferably used, however membranes with different configurations with base material being an inorganic oxide supported by a polymer fabric are also suitable. The materials considered for membranes include, but not limited to, oxide-ceramic materials, sulfonated polymers, perfluorinated sulfonated polymers and fiberglass-reinforced polyphenylene sulfides or polysulfones with inorganic oxides.

The bipolar plates as well as the spacers are mainly fabricated from nickel or nickel-coated steel. The spacers need to be designed in a way that they possess spring-like properties so the electrodes can be lightly pressed against the membrane with the spacers.

The electrolyte solution is preferably an aqueous alkali hydroxide solution and particularly preferably an aqueous sodium hydroxide or potassium hydroxide solution. In context of the present invention, the stack comprises N number of the cells, 2×N are the number of the electrodes with N number of cell membranes and 2×N number of the cell frames with 2×(N+1) number of the gaskets and N-1 bipolar plates and two end plates.

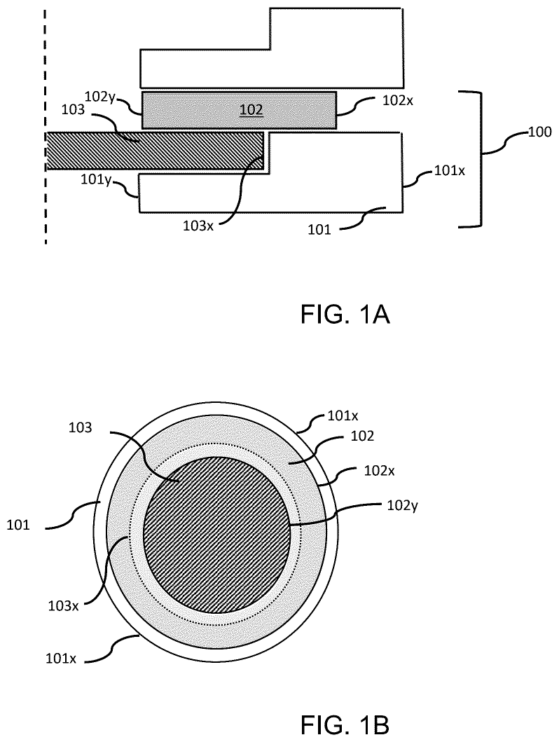

FIG. 1 illustrates a cell frame assembly 100 according to one embodiment of the present invention. As shown in FIG. 1A, the assembly 100 comprises a cell frame 101, a gasket 102 and a cell element 103. The cell element 103 comprises a peripheral edge 103x. The cell frame 101 comprising an outer peripheral edge 101x and an inner peripheral edge 101y, demonstrates rigid characteristics to provide mechanical support to the cell components enclosed within the cell frame assembly 100. On the other hand, the gasket 102 exhibits compressible characteristics that facilitates the gasket 102 to hold the cell element 103 in its position when subjected to compression. The cell element 103 is interposed between the cell frame 101 and the gasket 102 in such a manner that the gasket 102 overlaps a predefined part of the cell frame 101 and a predefined part of the cell element 103. In order to achieve efficient sealing of the cell frame assembly 100, the gasket 102 is designed as a hollow loop of a predefined width and thickness, comprising an outer peripheral edge 102x and an inner peripheral edge 102y.

As shown in FIG. 1B, the outer peripheral edge 102x of the gasket 102 extends outwards beyond the peripheral edge 103x of the cell element 103 in the direction of the outer peripheral edge 101x of the cell frame 101 such that a predefined part of gasket 102 overlaps the cell frame 101. Relatively, the inner peripheral edge 102y of the gasket 102 extends inwards away from the peripheral edge 103x of the cell element 103 in the direction of the inner peripheral edge 101y of the cell frame 101 such that a predefined part of the gasket 102 overlaps the cell element 103. The described assembly is exemplified as circular, but it is to be understood that the assembly components can be of any shape and their combination thereof within the scope of the invention.

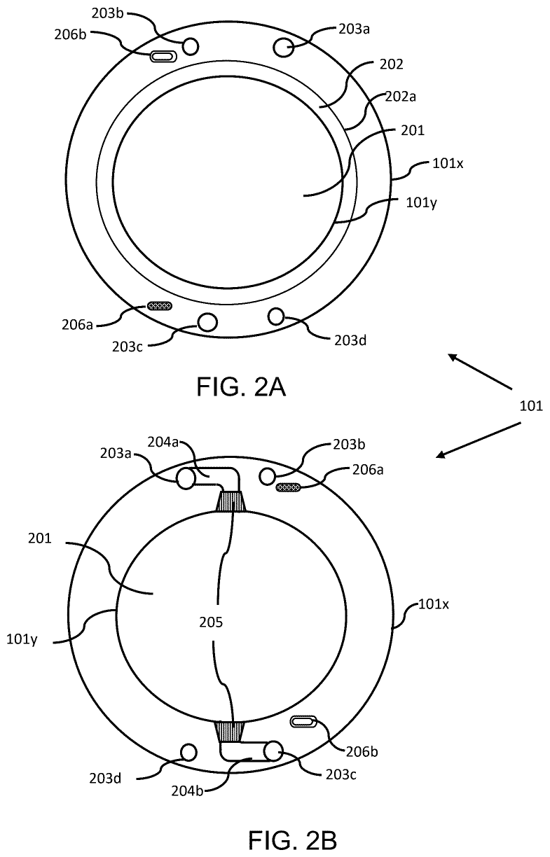

FIG. 2 illustrates frontal view of a cell frame, according to a preferred embodiment of the present invention. With respect to FIG. 2A, the cell frame 101 comprises a central opening 201 forming the inner peripheral edge 101y of the cell frame 101. The cell frame 101 comprises a groove 202 of a predefined width and depth, the groove 202 forms a peripheral edge 202a on the cell frame 101 in the space between the inner peripheral edge 101y of the cell frame 101 and the outer peripheral edge 101x of the cell frame 101. The width of groove 202 extends from the peripheral edge 202a of the groove 202 to the inner peripheral edge 101y of the cell frame 101. As the cell element 103 is received in the groove 202 of the cell frame 101, a spacing is provided between the peripheral edge 202a of the groove 202 and the peripheral edge 103x of the cell element 103 to compensate thermal expansion or contraction of the cell element during the startup, operation, and shutdown of the electrolyser. The groove 202 forms a step-like depression at the peripheral edge 202a; however, alternatively the groove 202 can vary to form different structures including, but not limiting to, a curved or inclined depression, a raised rib etc.

The cell frame 101 is primarily made of plastic including, but not limiting to, polysulfone, polyetheretherketone, acetal copolymer, polyethersulfone, polyphenylene, polyphenylene sulfide, polyphenylene oxide, polybenzimidazole, polyethyleneimine, polyamide-imides and other plastic polymers. The cell frame material can have fillers such as fibers, polyphenylene oxide and other suitable materials to provide additional strength and temperature tolerance. However, the cell frame can be made of metals, ceramics and other materials, and their combination thereof, with appropriate mechanical strength, thermal tolerance, electrically insulating properties and chemical resistance to withstand alkaline environment.

The cell frame 101 further comprises a plurality of channels 203a, 203b, 203c, 203d for the media including, but not limited to, electrolyte solution and product gases, to enter and exit the cell. The cell frame furthermore comprises at least one pathway 204a, 204b connecting at least one channel to the central opening of the cell frame 101. The pathways 204a, 204b provide passage to supply and discharge media to/from the central opening 201 through the cell frame to reach the channels.

According to one embodiment herein, the channels 203a to 203d are divided into two sets, each set comprising at least two channels, when one set of channels act as inlets then the other set of channels act as outlets. Referring to FIG. 2B, channels 203a, 203b form one set and the channels 203c, 203d form the second set of the channels. The functionality of channels 203a to 203d as inlets and outlets depends on the arrangement of cell frame 101 with respect to the electrolyser stack. The channels in one set are placed apart by a predefined distance, positioned next to each other. However, the two sets of channels are placed at about 180 degrees apart.

FIG. 2B illustrates the positioning of channels 203a to 203d in the cell frame 101, for example, considering the cell frame 101 to be arranged such that the channels 203a, 203b are at the top section of the stack and the channels 203c, 203d are at the bottom section of the stack. With this arrangement the channels 203a, 203b act as outlets and function as product-gas discharging channels whereas the channels 203c, 203d act as inlets and function as electrolyte solution supplying channels.

According to one embodiment herein, each set of channels has at least one pathway 204a, 204b connecting the central opening 201 of the cell frame 101 to one of the channels in the said channel set. Hence each pathway is 180 degrees apart and forms an inlet pathway and an outlet pathway based on the placement of the cell frame 101.

The inlet pathway supplies the electrolyte solution from the inlet channels to the cell whereas the outlet pathway discharges the gases produced by the cell to the outlet channels.

Again, with respect to FIG. 2B, pathway 204a connects channel 203a to the central opening 201 of the cell frame 101 and pathway 204b connects channel 203c to central opening 201 of the cell frame 101. Assuming that hydrogen is discharged at one side of the stack and oxygen is discharged at other side of the stack, the cell frame 101 discharging hydrogen is assembled to position the channel 203a, 203c and the pathway 204a, 204b on the hydrogen side of the cell. Similarly, when the cell frame 101 is placed at the oxygen side of the cell, the cell frame 101 is rotated circumferentially by 180 degrees with respect to the cell frame 101 at the hydrogen side so that the channel 203a, 203c and the pathway 204a, 204b are aligned to be at the oxygen side of the cell.

The cell frame 101 comprises a bridge 205 at the junction of the pathway and the central opening. When the gasket 102 is compressed against the cell frame 101, the bridge 205 avoids interference of the gasket 102 with the pathways 204a, 204b, so that the media is free to move to/from the cell to the respective channels through the pathway and ensures even gasket compression at the junction location. The bridge 205 is made of any material with rigid and non-compressible properties, mechanically resistant enough to prevent the gasket 102 from collapsing into the pathway.

The cell frame 101 has two sides, a first surface as depicted in FIG. 2A, and a second surface as depicted FIG. 2B. The groove 202 is placed preferably on the first surface of the cell frame 101, whereas the pathways 204a, 204b and the bridge 205 are present on the second surface of the cell frame 101. Thus, when the cell frames 101 are arranged in alternating manner, the second surface of the cell frame 101 faces the first surface of the adjacent cell frame, the gasket 102 placed on the first surface of the cell frame 101 receives compression from the second surface of the adjacent cell frame.

Both sides of the cell frame 101 further comprise a plurality of protruding parts 206a and recesses 206b on both surfaces of the cell frame 101 to align the gasket 102 and the cell frame 101. Furthermore, the protruding parts 206a of the cell frame fit into recesses of the adjacent cell frame to lock the two cell frames 101 in place.

The gasket is made up of thermoset materials including, but not limited to Polytetrafluoroethylene (PTFE), expanded PTFE, glass filled PTFE, vulcanized or peroxide-crosslinked ethylene-propylene-diene rubber (EPDM) or ethylene-propylene rubber (EPM), fluoroelastomer, nitrile butadiene rubber, tetrafluoroethylene-perfluoroalkyl vinyl ether copolymer (PFA).

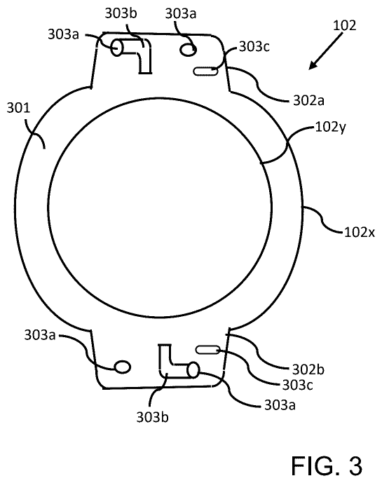

Referring to FIG. 3, the gasket 102 comprises at least two extended portions 302a, 302b overlapping a predefined part of the cell frame around the channels and the pathways. The extended portions comprise a plurality of apertures 303a, 303b to accommodate the channels and the pathways present on the cell frame, respectively. Hence the extended portions 302a, 302b are placed at 180 degrees apart.

The extended portions 302a, 302b of the gasket 102 furthermore comprises the apertures 303c to accommodate the protruding parts of the cell frame. The gasket 102 is aligned on the cell frame such that the apertures 303a, 303b, 303c on the gasket 102 are positioned in accordance with the channels, the pathways and the protruding parts of the cell frame.

According to an alternate embodiment herein, the extended portions can be of indefinite shape, wherein the shape depends on the various factors including but not limiting to placement and structure of the pathways, the number of channels and protruding parts etc. However, according to alternate embodiment, entire outer peripheral edge of the gasket can be extended to include the apertures, thus eliminating the need for the extended portions.

Referring back to FIG. 1B, the cell element 103 placed in the groove of the cell frame 101 is either a bipolar plate or a cell membrane. The surface area of the cell element 103 is designed so that the area does not surround the transverse channels in-order to minimize the parasitic shunt currents, thus making the arrangement energy efficient. Other cell components such as, but not limited to electrodes and spacers are suspended in the central opening of the cell frame 101.

The stack is configured to be either round, square or rectangular in shape based on the functionality requirements of the stack. In appropriate alternative embodiments, the cell frame 101 has a non-circular shape, e.g., a rectangular disk shape, an oval shape, or a polygonal shape with fewer or more than four corners.

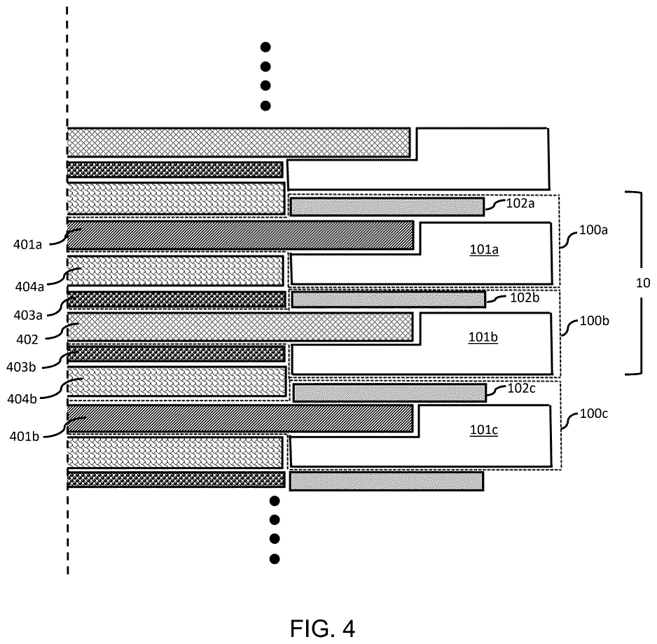

FIG. 4 is a cross sectional view of a cell arrangement according to a preferred embodiment of the present invention. With respect to FIG. 4, the cell 10 is assembled with two components: a bipolar-plate assembly 100a and a cell-membrane assembly 100b. The bipolar-plate assembly 100a comprises a bipolar plate 401a interposed between a first cell frame 101a and a first gasket 102a. Similarly, the cell-membrane assembly 100b comprises a cell membrane 402 interposed between a second cell frame 101b and a second gasket 102b. The cell frames 101a, 101b used in both assemblies can be identical, however the arrangement of the successive cell frames 101a, 101b differs between the assemblies. The bipolar-plate assemblies and the cell-membrane assemblies can be stacked together in an alternating pattern between the end plates, wherein the successive cell frames of the assemblies can be arranged by relatively rotating the cell frames by 180 degrees with respect to each other. In such an embodiment, the cell frame 101a of the bipolar-plate assembly 100a is rotated 180 degrees with respect to the cell frame 101b of the cell-membrane assembly 100b.

As seen from FIG. 4, each cell frame assembly 100 further comprises at least one electrode and at least one spacer that are placed in the central opening of the cell frame 101. Therefore, a first electrode 403a and a first spacer 404a are enclosed between the bipolar-plate assembly 100a and the cell membrane assembly 100b, wherein the spacer 404a is placed next to the bipolar plate 401a and the first electrode 403a is placed next to the first spacer 404a. Similarly, a second electrode 403b and a second spacer 404b are enclosed between the cell-membrane assembly 100b and the bipolar-plate assembly 100c of an adjacent cell such that the second electrode 403b is placed next to the cell membrane 402 and the second spacer 404b is placed next to the electrode 403b. When the bipolar-plate assembly 100a and the cell membrane assembly 100b are stacked together, the first electrode 403a of bipolar-plate assembly 100a and the second electrode 403b of the cell-membrane assembly 100b will be placed on either side of the cell membrane 402 and the spacers 404a, 404b press the electrodes 403a, 403b against the cell membrane 402 to achieve the zero-gap configuration.

The peripheral edge of the electrodes 403a, 403b and the peripheral edge of the spacers 404a, 404b is smaller than or equal to the inner peripheral edge 101y of the cell frame 101 so that the electrodes 403a, 403b and the spacers 404a, 404b are placed in the central opening 201 of the cell frame 101 in order to protect the electrodes and ensure proper sealing of the cell to avoid leakage of the electrolyte solution.

When the cells are clamped and compressed between the first end plate and the second end plate, the cell frame 101a from the bipolar-plate assembly 100a compresses the gasket 102b of the cell-membrane assembly 100b to hold the cell membrane 402. Similarly, the cell frame 101b of the cell-membrane assembly 100b compresses the gasket 102c of the adjacent bipolar-plate assembly 100c to hold the bipolar plate 401b in place. The cell frames 101a, 101c of the bipolar-plate assemblies 100a, 100c are identical.

At the first end plate or the second end plate of the stack, according to alignment of the cell elements in the stack, an additional gasket is placed to provide compression to the first cell or the end cell. Therefore, the total number of gaskets in the stack is one more than the number of cell frames.

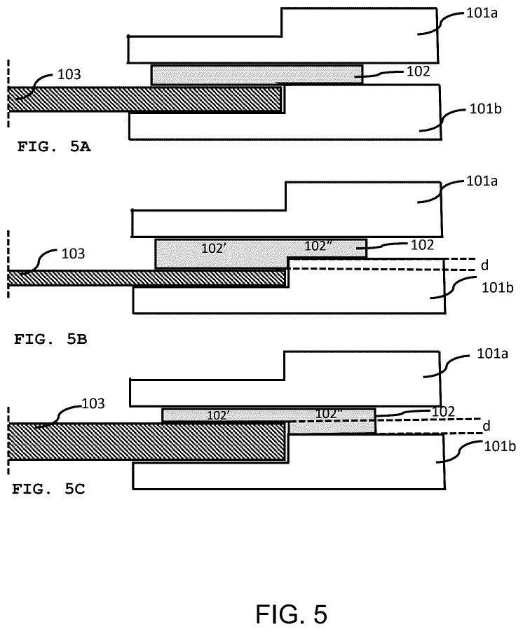

Another embodiment of the invention demonstrates a simple adaptation of the cell frame assembly 100 to receive the cell element with different thicknesses. The gasket 102 is compressed to adapt according to variable thickness of the cell element 103. The thickness of the gasket 102 is calculated based on the thickness of the cell element 103, where following equation is satisfied:

$$t \geq ( \frac{( \vert d \vert + {t}_{0} )}{c} )$$

wherein t is thickness of the gasket 102 before compression, d is absolute value of gap between the surface of cell element 103 facing the gasket 102 and the peripheral edge of the groove of the cell element 103 in compressed state (as shown in FIG. 5B, 5C), to is tolerance of the gasket 102, c is compressibility of the gasket 102 in percentage.

FIG. 5A, 5B and FIG. 5C represent cross-section view of the cell assembly to illustrate compression of gasket according to different embodiments of the present invention. The gasket 102 of the cell frame assembly 100 is adapted to variably accommodate different thickness of the cell element 103 inserted into the groove 202 of the cell frame 101. The gasket 102 is configured to compensate the gaps formed due to different thickness of the cell element 103 and seal the space between the two adjacent cell frames to avoid leakage of the electrolyte.

With respect to FIG. 5A, according to one embodiment of the present invention, the thickness of the cell element 103 is same as the depth of the groove 202 of the cell frame 101b. Upon applying pressure, the gasket 102 has uniform thickness across the overlapping area in contact with the cell element 103 and the cell frame 101, thus sealing the space between adjacent cell frame assemblies.

With respect to FIG. 5B, according to one embodiment of the present invention, the thickness of the cell element 103 is lesser than the depth of the groove 202 of the cell frame 101b. Upon applying pressure, as the cell frame 101a compresses the gasket 102 against the cell frame 101b and the cell element 103, the thickness of the gasket 102″ in contact with the cell frame 101 has reduced, and the thickness of the gasket 102′ overlapping the cell element 103 is greater compared to the thickness of the gasket 102″ in contact with the cell frame 101 as the gasket 102 fills in space between the cell element 103 surface in contact with the first surface of the gasket 102 and the cell frame 101b in contact with the second surface of the gasket 102.

With respect to FIG. 5C, according to one embodiment of the present invention, the thickness of the cell element 103 is greater than the depth of the groove 202 of the cell frame 101b. Upon applying pressure, as the gasket 102 is compressed between the cell element and the cell frame 101b, the thickness of the gasket 102′ overlapping the cell element 103 is less compared to the thickness of gasket 102″ in contact with the cell frame 101b.

Hereinafter, an example of the present invention is described. It will be understood that the example is only illustrative for the purpose of describing the overlapping aspect of the cell frame assembly according to the present invention and is not intended to limit the present invention in any way.

Considering a pressurized alkaline water electrolyser with circular cell components, each cell comprises two cell frames, two gaskets, one bipolar plate and one cell membrane. The overlapping aspect of the present invention is illustrated with respect to the diameter of the cell components. The cell components are defined by a predetermined diameter as mentioned below:
Inner diameter of cell frame: 350 mm
Outer diameter of cell frame: 490 mm
Inner diameter of the gasket: 350 mm
Outer diameter of the gasket: 405 mm
Diameter of the cell element: 385 mm

When the cell components are arranged as per the cell frame assembly depicted in FIG. 1B, the dimensions of the cell components enable the gasket to overlap part the cell frame and part of the cell element.

Gasket overlapping part of the cell element is calculated as diameter of cell element minus the inner diameter of gasket: 35 mm

Gasket overlapping part of the cell frame is calculated as outer diameter of gasket minus the diameter of the cell element: 20 mm

The above detailed description of various embodiments clearly discloses advantages of the present invention to provide a cell frame assembly which reduces the complexity of frame fabrication. The cell frame together with gasket ensures a secure and reliable seal, reducing the risk of leaks and ensuring the system operates as intended.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all the generic and specific features of the embodiments described herein and all the statements of the scope of the embodiments which as a matter of language might be said to fall there between.

1. An electrolyser cell frame assembly comprising:
a cell frame with an inner peripheral edge and an outer peripheral edge, wherein the cell frame exhibits rigid characteristics;
a gasket with an inner peripheral edge and an outer peripheral edge, wherein in the gasket exhibits compressible characteristics; and
a cell element with a peripheral edge, compressed between the gasket and the cell frame;
wherein the outer peripheral edge of the gasket extends outwards over the peripheral edge of the cell element in the direction of the outer peripheral edge of the cell frame such that the gasket overlaps a predefined part of the cell frame;
wherein the inner peripheral edge of the gasket extends inwards over the peripheral edge of the cell element in the direction of the inner peripheral edge of the cell frame such that the gasket overlaps a predefined part of the cell element; and
wherein the gasket is positioned to overlap the part of the cell frame and the part of the cell element along the entire peripheral edge of the cell element.

2. The cell frame assembly according to claim 1, wherein the cell frame comprises a central opening, a groove for accommodating the cell element, a plurality of transverse channels (203a-203d) and at least two pathways; (204a, 204b); wherein each pathway interconnects at least one channel to the central opening.

3. The cell frame assembly according to claim 2, wherein the two pathways (204a, 204b) are spaced apart by about 180 degrees.

4. The cell frame assembly according to claim 2, wherein the cell frame further comprises a bridge at junction of the pathway (204a or 204b) and the central opening.

5. The cell frame assembly according to claim 2, wherein the cell frame comprises a first surface and a second surface, wherein the groove is present on the first surface of the cell frame and wherein the pathways (204a or 204b) and the bridge are located on the second surface of the cell frame.

6. The cell frame assembly according to claim 2, wherein the gasket comprises at least two extended portions (302a, 302b) overlapping a predefined part of the cell frame around the channels (203a-203d) and the pathways (204a or 204b).

7. The cell frame assembly according to claim 6, wherein the extended portion (302a or 302b) of the gasket comprises a plurality of apertures (303a-303c) to accommodate the plurality of channels and the pathways (204a or 204b).

8. The cell frame assembly according to claim 1, wherein the cell element is either a cell membrane or a bipolar plate.

9. The cell frame assembly according to claim 2, wherein the cell frame comprises a plurality of protruding parts and recesses that fit into each other to align the cell frame and the gasket in the cell frame assembly.

10. The cell frame assembly according to claim 2, wherein the groove comprises a spacing between a peripheral edge of the groove and the peripheral edge of the cell element to compensate thermal expansion or contraction of the cell element.

11. An electrolyser, preferably alkaline water electrolyser, comprising:
a first end plate and a second end plate;
a plurality of cells serially stacked in-between the first end plate and the second end plate;
wherein each cell comprises:
a bipolar-plate assembly comprising a bipolar plate placed between a first cell frame and a first gasket;
wherein the first gasket is assembled to overlap a predefined part of the first cell frame and a predefined part of the bipolar plate;
a cell-membrane assembly, comprising a cell membrane placed between a second cell frame and a second gasket;
wherein the second gasket is assembled to overlap a predefined part of the second cell frame and a predefined part of the cell membrane;
a plurality of electrodes, and a plurality of spacers;
wherein a first electrode and a first spacer are placed in-between the bipolar-plate assembly and the cell-membrane assembly; and
wherein a second electrode and a second spacer are placed in-between the cell-membrane assembly and the bipolar-plate assembly of an adjacent cell.

12. The electrolyser according to claim 11, wherein the first cell frame is structurally identical to the second cell frame.

13. The electrolyser according to claim 12, wherein the bipolar-plate assembly and the cell-membrane assembly are arranged in an alternating pattern, wherein the first cell frame and the second cell frame are arranged by alternately rotating the cell frames by 180 degrees.

14. The electrolyser according to claim 11, wherein the first gasket of the bipolar-plate assembly is compressed between a cell frame of an adjacent cell-membrane assembly, the first cell frame and the bipolar plate of the bipolar-plate assembly, and wherein the second gasket of the cell-membrane assembly is compressed between the first cell frame of the bipolar-plate assembly, the second cell frame and the cell membrane of the cell-membrane assembly.

15. The electrolyser according to claim 12, wherein the peripheral edge of the first electrode and the second electrode is either lesser than or equal to the inner peripheral edge of the cell frame; wherein the peripheral edge of the first spacer and the second spacer is either smaller than or equal to the inner peripheral edge of the cell frame.

16. The electrolyser according to claim 14, wherein the total number of gaskets in the stack is one more than the number of cell frames, wherein an additional gasket is placed either after the first end plate or before the second end plate.
